(19) United States
(12) Patent Application Publication
(10) Pub. No.: US 2006/0083805 A1
(43) Pub. Date: Apr. 20, 2006

(54) Corrugating machine

(76) Inventor: Richard Gardiner, Peterstow (GB)

Correspondence Address: YOUNG & THOMPSON, 745 SOUTH 23RD STREET, 2ND FLOOR, ARLINGTON, VA, 22202, US

(21) Appl. No.: 10/967,240

(22) Filed: Oct. 19, 2004

(51) Int. Cl. B29C 53/20

(52) U.S. Cl. 425/369

(57) ABSTRACT

A corrugating machine comprises a guide path along which a sheet of flexible material can be fed, a pair of rotatable members between which the guide path extends, and a plurality of elongate corrugating formers which can be engaged with and disengaged from the rotatable members. The rotatable members are spaced so that, in use, the elongate corrugating formers, when engaged with the rotatable members, cooperate to form corrugations in the flexible sheet as the flexible sheet passes between the rotatable members.

### INTRODUCTION

This invention relates to a corrugating machine.

Known corrugating machines for forming corrugated board have intermeshing rollers. The outer surfaces of the rollers are integrally formed with elongate grooves and ridges which extend the length of the roller in parallel with its rotational axis. Since the rollers are positioned so that the grooves of one roller can intermesh with the ridges of the other roller, when a sheet of flexible material, such as paper or card, is fed therebetween, transversely extending corrugations are formed along its length.

As the corrugated flexible material exits from the nip between the intermeshing rollers, the material is held to one of the rollers, either by suction or pressing, so that a first liner can be bonded to one surface of the corrugated flexible material. Thereafter, the corrugated flexible material is released from the roller so that a second liner can be bonded to the other surface of the corrugated flexible material.

A problem that occurs is that the grooves and ridges of the rollers, when taking a transverse cross-section, have a sinusoidal or substantially sinusoidal profile. This causes the flexible material to be formed with sinusoidal or substantially sinusoidal corrugations. Corrugations of this type, i.e. having a surface that follows a continuously curving path, tend to be relatively weak under compression.

Furthermore, since the ridges of the corrugations are arcuate, the liners, which can only be applied successively, have very little surface area to adhere to. This can easily lead to delamination.

Traditional corrugating machines only put adhesive on to the tips of the corrugations, which compounds the problem of delamination.

To promote adhesion of the liners, starch-based adhesives are used. However, this has to be applied hot under particular ambient conditions, which can be problematic to achieve.

The present invention seeks to overcome these problems.

### SUMMARY OF THE INVENTION

According to a first aspect of the present invention, there is provided a corrugating machine comprising a guide path along which a sheet of flexible material can be fed, a pair of rotatable members between which the guide path extends, and a plurality of elongate corrugating formers which can be engaged with and disengaged from the rotatable members, the rotatable members being spaced so that, in use, the elongate corrugating formers, when engaged with the rotatable members, cooperate to form corrugations in the flexible sheet as the flexible sheet passes between the rotatable members.

According to a second aspect of the present invention, there is provided a corrugating machine comprising a guide path along which a sheet of flexible material can be fed, a plurality of sets of elongate corrugating formers, a holder at one end of each elongate former, the elongate formers of a first set extending from respective holders in a first direction and the elongate formers of a second set extending from respective holders in a second direction opposite the first direction, means for guiding the holders of each set of elongate formers along an endless track and for moving the elongate formers transversely of the guide path, and a pair of rotatable members which drive the elongate formers around arcuate paths at the upstream end of the guide path while a sheet of flexible material to be corrugated is passed along the guide path between the two sets of elongate formers.

According to a third aspect of the present invention, there is provided a corrugating machine comprising a guide path along which a sheet of flexible material can be fed, a pair of rotatable members between which the guide path extends, a plurality of elongate corrugating formers on the rotatable members, and means, downstream of the rotatable members, for feeding first and second liners into the guide path, the rotatable members being spaced so that, in use, the elongate corrugating formers cooperate to form corrugations in the flexible material as the flexible material passes between the rotatable members, and first and second liners are simultaneously or substantially simultaneously fed from the first and second liner feeding means to sandwich the corrugated flexible material therebetween.

Preferably, the corrugating machine further comprises means for applying an adhesive to opposing surfaces of the first and second liners prior to being fed into the guide path so that, when the corrugated flexible material is sandwiched therebetween, the first and second liners are bonded to the corrugated flexible material.

According to a fourth aspect of the present invention, there is provided corrugated material comprising corrugations having flat or substantially flat ridges and flat or substantially flat sides.

The present invention will now be described, by way of example, with reference to the accompanying drawings.

### BRIEF DESCRIPTION OF THE DRAWINGS

FIG. 1 is a diagrammatic side view of a part of one embodiment of an in use corrugating machine, in accordance with the first, second and third aspects of the present invention;

FIG. 2 is an enlarged side view of parts of the holder engaging members shown in FIG. 1;

FIG. 3 is a diagrammatic end view along the line A-A in FIG. 1 with the material to be corrugated removed;

FIG. 4 is an enlarged view of part of FIG. 3 showing the ends of the rotatable members and endless tracks;

FIG. 5 is an enlarged view of part of FIG. 4 showing the ends of the rotatable members and endless tracks;

FIG. 6 is a schematic top plan view of the corrugating machine shown in FIG. 1 with the majority of elongate formers removed for clarity; and

FIG. 7 is a diagrammatic side view of corrugated material, in accordance with the fourth aspect of the present invention, formed by the corrugating machine.

### DESCRIPTION OF THE PREFERRED EMBODIMENTS

Referring to the drawings, a corrugating machine 10 for forming corrugated board is shown therein. The corrugating machine 10 comprises a support structure 12, a guide path 14 which passes through the support structure 12, a pair of rotatable members, typically in the form of top and bottom corrugating rollers 16 and 18, which are held by the support structure 12 at an upstream end 20 of the guide path 14 and between which the guide path 14 extends, a plurality of elongate corrugating formers 22, and a plurality of endless tracks 24 which are supported by the support structure 12 and on which sets of the elongate formers 22 can slide.

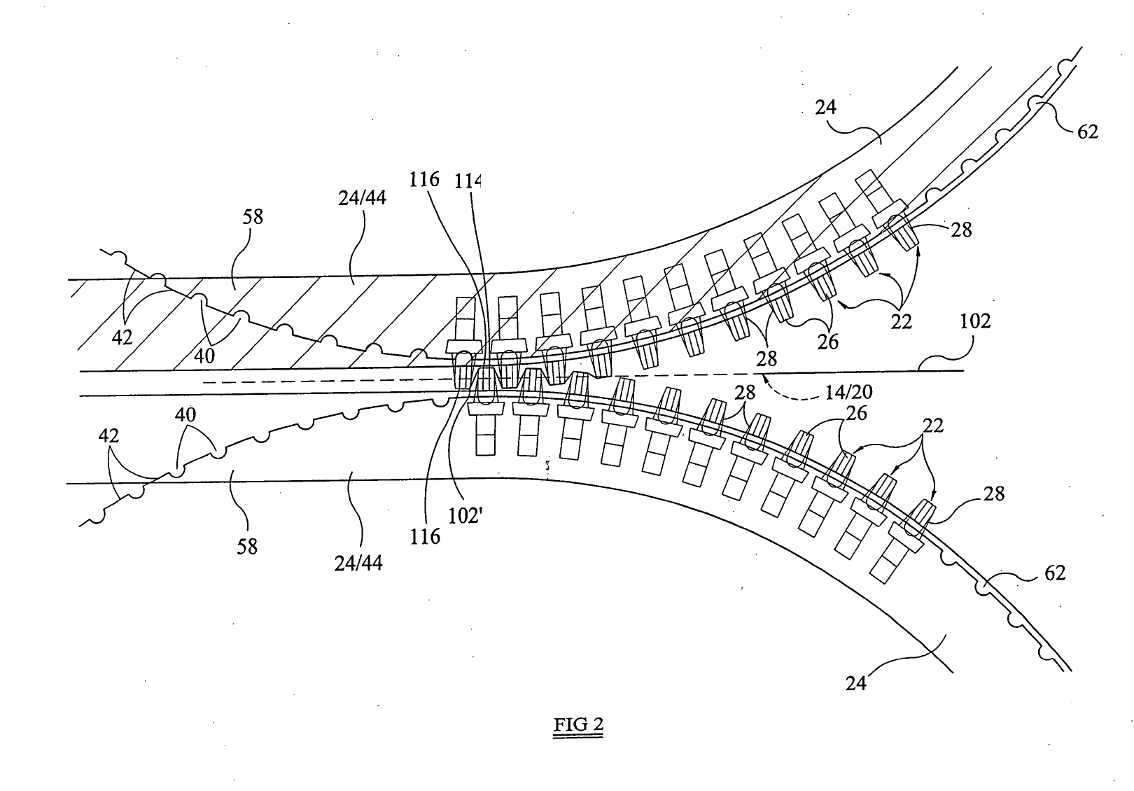

As can be seen in FIG. 2, a longitudinal forming part 26 of each elongate former 22 has a square or rectangular shaped transverse cross-section.

Each elongate former 22 also includes a separate holder 28 at one end thereof. Each holder 28 has a corrugating roller engaging part 30 and a track engaging part 32.

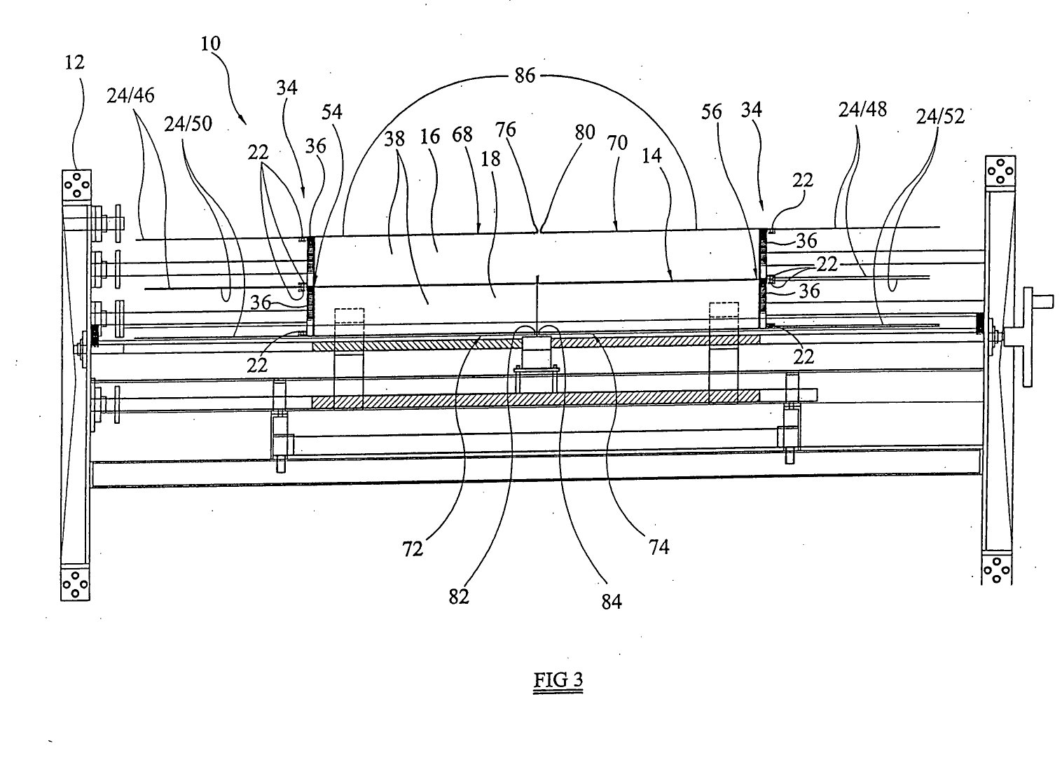

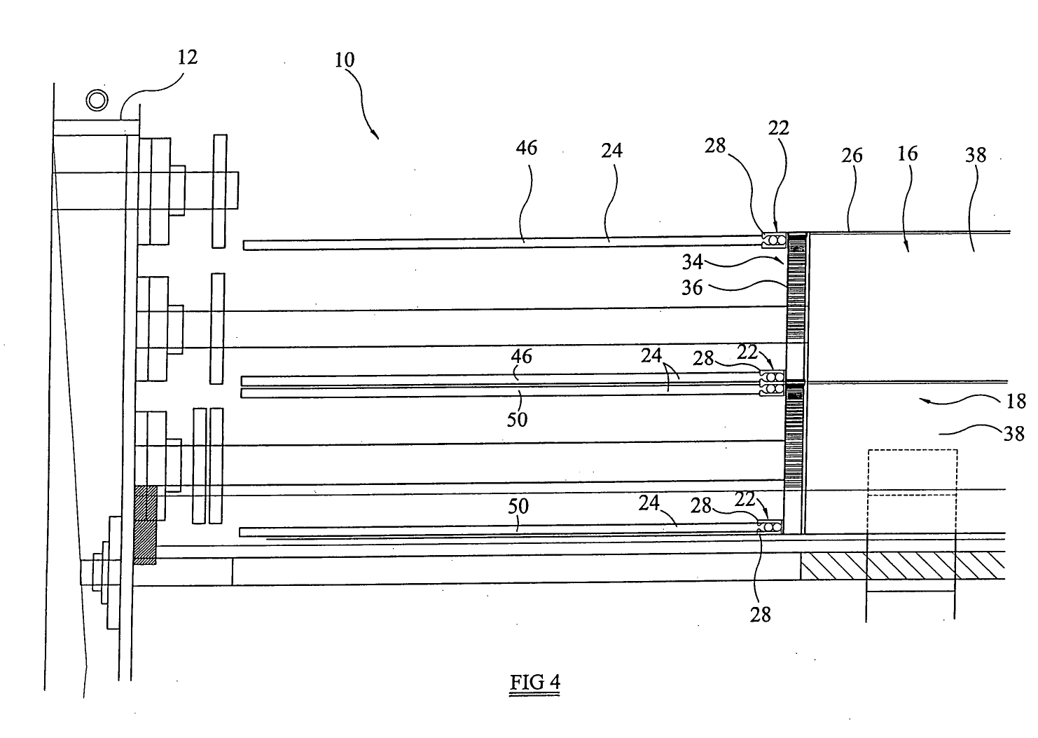

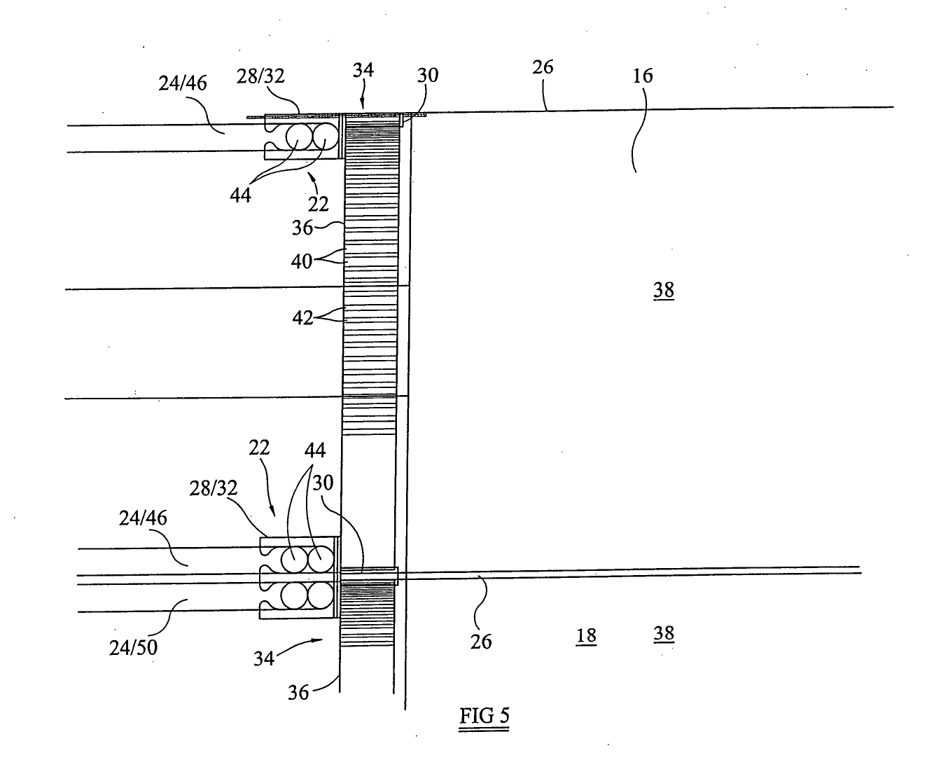

As best shown in FIGS. 2 to 5, each end 34 of each corrugating roller 16, 18 includes a holder engaging member 36 in the form of a disk mounted coaxially with, and stationary relative to, the body 38 of the corrugating roller 16, 18. An equal number of holder receiving grooves 40 and ridges 42 are formed in the outer surface of each holder engaging member 36 and extend parallel to the rotational axis of the respective corrugating roller 16, 18. The holder receiving grooves 40 are dimensioned to be engageable with the roller engaging part 30 of the holders 28, and, although not shown in FIG. 2, the ridges 42 are shaped to promote entry and exit of the holder 28 into and from the grooves 40.

The body 38 of the corrugating roller 16, 18 can provide support for the longitudinal forming parts 26 of the elongate formers 22.

The elongate formers 22 are continuously provided without interruption around the endless tracks 24, and the holders 28 act to regulate the space between adjacent elongate formers 22. The corrugating machine 10 is provided with 4200 individual elongate formers 22. However, this number may vary depending on the size of the corrugations required and the length of the guide path 14.

To provide torsional rigidity, each endless track 24 is typically formed from two 5 mm diameter rods 44 attached to each other, and the track engaging parts 32 of the holders 28 fit over both rods 44 so as to be slidable there along.

One endless track 24 is positioned adjacent to each holder engaging member 36, which results in a top pair 46, 48 of endless tracks 24 being associated with the top corrugating roller 16 and a bottom pair 50, 52 of endless tracks 24 being associated with the bottom corrugating roller 18.

The endless tracks 24 of each pair 46, 48 and 50, 52 are positioned on opposite longitudinal sides 54, 56 of the guide path 14 and extend in parallel with the longitudinal extent of the guide path 14. The downstream run 58 of each endless track 24 lies in or substantially in the plane of the guide path 14, and the upstream run 60 lies in a plane which is parallel or substantially parallel to the guide path 14.

The portion 62 of each endless track 24 adjacent to its respective holder engaging member 36 follows an arcuate path which has a radius equal or substantially equal to the radius of the holder engaging member 36.

The portion 64 of each endless track 24 at the downstream end 66 of the guide path 14 also follows an arcuate path which has a radius equal or substantially equal to the radius of the holder engaging member 36.

The plurality of elongate formers 22 are arranged in four sets which are apportioned so that the top corrugating roller 16 has first and second sets 68 and 70 of the elongate formers 22 associated with it, and the bottom corrugating roller 18 has first and second sets 72 and 74 of the elongate formers 22 associated with it.

The first top set 68 and the first bottom set 72 of elongate formers 22 extend from their respective holders 28 across the guide path 14 in a first direction, which is in parallel or substantially in parallel with the rotational axes P of the corrugating rollers 16, 18.

The second top set 70 and the second bottom set 74 of elongate formers 22 extend from their respective holders 28 in a second direction, which is opposite to the first direction.

Since the forming parts 26 of the elongate formers 22 are rigid, directly transversely opposing elongate formers 22 can, in use, travel around their respective endless tracks 24 while remaining longitudinally aligned or substantially longitudinally aligned with each other.

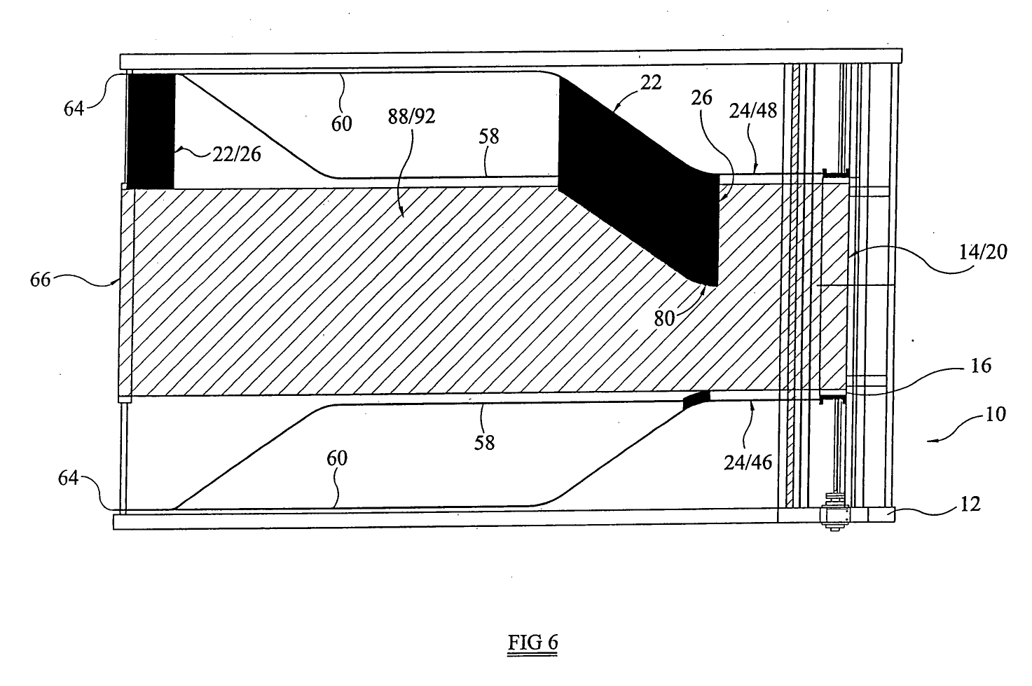

As can best be seen in FIG. 6, each endless track 24 follows a path which enables the elongate formers 22 of the associated set 68, 70 and 72, 74 to be moved transversely of the guide path 14. Towards the ends of the upstream runs 60 of the endless tracks 24, the paths of the transversely opposing endless tracks 46, 48 and 50, 52 are configured to converge so that the free-ends 76, 80 of the top elongate formers 68, 70 meet or substantially meet and the free-ends 82, 84 of the bottom elongate formers 72, 74 meet or substantially meet prior to the holders 28 engaging with the holder engaging members 36 of the respective corrugating rollers 16, 18. Each pair of transversely opposing elongate formers 68, 70 and 72, 74 can thus define a single former 86 which can extend across the entire longitudinal extent of the respective corrugating roller 16, 18.

Towards the ends of the downstream runs 58 of the endless tracks 24, after the holders 28 have disengaged from the holder engaging members 36, the paths of the transversely opposing endless tracks 46, 48 and 50, 52 are configured to diverge so that the transversely opposing top elongate former 68, 70 move apart from each other and the transversely opposing bottom elongate formers 72, 74 move apart from each other.

Adjacent top and bottom holder engaging members 36 are spaced and angularly offset relative to each other so that, as the elongate formers 22 travel around the endless tracks 24, the top elongate formers 68, 70 can mesh with, or be interposed between, the bottom elongate formers 72, 74, as shown in FIG. 2.

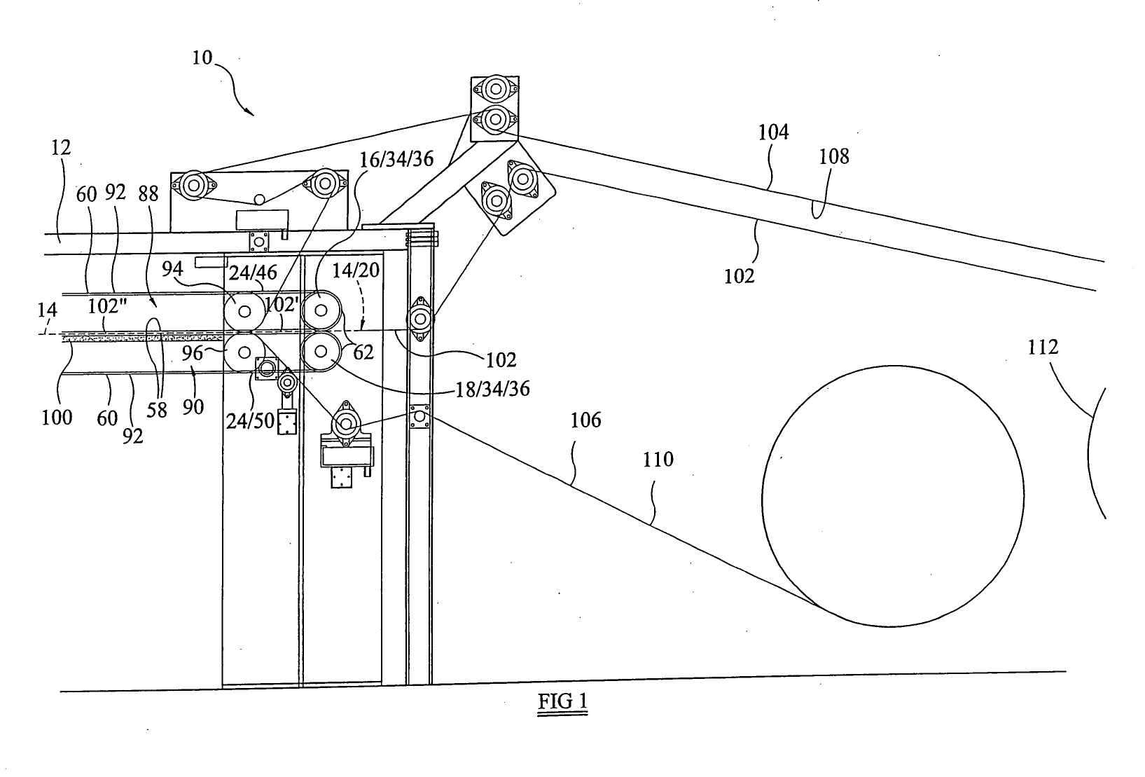

Top and bottom conveyors 88, 90 are also provided downstream of the corrugating rollers 16, 18. Each conveyor 88, 90 has a conveyor belt 92 entrained around two spaced conveyor rollers (only one of which is shown in FIG. 1 and referenced as 94 and 96, respectively) of equal or substantially equal diameter to the corrugating rollers 16, 18. The conveyors 88, 90 are positioned so that the guide path 14 extends between them.

The corrugating rollers 16, 18 and conveyors 88, 90 are typically powered by a motor and chain drive arrangement. The conveyor rollers 94, 96 at the upstream end 20 of the guide path 14 are typically driven rollers, and the conveyor rollers at the downstream end 66 of the guide path 14 are typically idler rollers. However, the downstream conveyor rollers may also be driven, if necessary.

To prevent undesirable bowing of the conveyor belts 92, a support bed 100 is provided between the conveyor rollers of the bottom conveyor 90.

The conveyor belts 92 support the top and bottom elongate formers 68, 70 and 72, 74, when disengaged from the corrugating rollers 16, 18, and are sufficiently wide so that, even when the elongate formers 68, 70 and 72, 74 are moved transversely of the guide path 14 due to the endless tracks 24, the forming parts 26 are still supported.

The downstream runs 58 of the top and bottom endless tracks 46, 48 and 50, 52 extend to positions which are adjacent to the ends of the respective idler rollers of the top and bottom conveyors 88, 90. The endless tracks 24 follow the paths of the respective top and bottom conveyor belts 92 around the idler rollers so that the top elongate former 68, 70 are supported by the conveyor belt 92 of the top conveyor 88 as they move back upstream towards the top corrugating roller 16.

To enable the bottom elongate formers 72, 74 to be supported while moving back upstream, a third conveyor (not shown) may be provided below the bottom conveyor 90. The third conveyor is powered by the aforementioned motor and chain drive arrangement.

The corrugating machine 10 also includes means for feeding a flexible material 102 to be corrugated into the guide path 14 so that it passes between the top and bottom corrugating rollers 16, 18, and means for feeding first and second liners 104, 106 into the guide path 14 at the nip of the top and bottom conveyors 88, 90, downstream of the top and bottom corrugating rollers 16, 18.

Means in the form of applicators (not shown) for applying an adhesive to opposing surfaces 108, 110 of the first and second liners 104, 106 are also provided at positions prior to the first and second liners 104, 106 being introduced into the guide path 14.

The adhesive is typically, but not necessarily, a polyvinyl acetate (PVA) adhesive and, as such, can be applied cold. However, a hot-type glue may also be used.

In use, the corrugating machine 10 is energised so that the top and bottom corrugating rollers 16, 18 and the conveyors 88, 90 rotate. Since the number of elongate formers 22 is sufficient to provide a continuous and uninterrupted flow of elongate formers 22 to the top and bottom corrugating rollers 16, 18, as the top and bottom corrugating rollers 16, 18 rotate, pairs of transversely opposing elongate formers 68, 70 and 72, 74 are successively disengaged from the grooves 40 due to the respective holders 28 following the downstream run 58 of the endless tracks 24. The elongate formers 22 are thus all moved around the endless tracks 24 by the top and bottom corrugating rollers 16, 18, which results in pairs of transversely opposing elongate formers 68, 70 and 72, 74 that are moving along the upstream run 60 of the endless tracks 24 successively re-engaging with the grooves 40 of the corrugating rollers 16, 18.

A continuous and uninterrupted cycle of disengagement and re-engagement of the elongate formers 22 with the top and bottom corrugating rollers 16, 18 is thus setup.

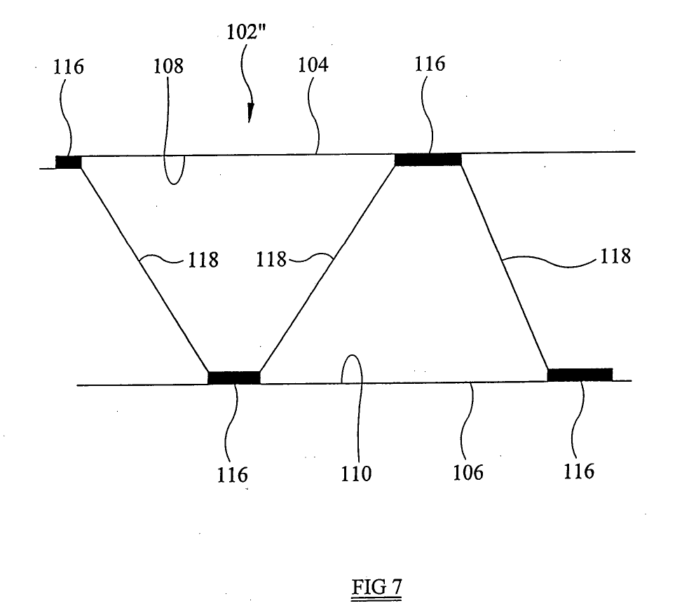

A sheet of flexible material 102 to be corrugated, typically being paper or card, is fed via the material feeding means from a supply roll 112 into the guide path 14. The flexible material 102 moves into the nip between the top and bottom corrugating rollers 16, 18 and is corrugated due to the meshing or interposing of the top and bottom elongate formers 68, 70 and 72, 74. As can be seen in FIGS. 2 and 7, due to the shape of the elongate formers 22, the flexible material 102 is only bent at a limited number of points leading to corrugations which have flat ridges 116 and flat sides 118.

As the corrugated flexible material 102′ exits from between the nip of the top and bottom corrugating rollers 16, 18, the elongate formers 68, 70 and 72, 74 which formed the corrugations disengage from the rotating corrugating rollers 16, 18 and remain in the formed corrugations 114. The corrugated flexible material 102′ and the elongate formers 68, 70 and 72, 74 thus move together along the guide path 14 towards the conveyors 88, 90.

The first and second liner feeding means feed the first and second liners 104, 106, which have adhesive on opposing surfaces 108, 110, into the nip between the conveyors 88, 90. The nip between the conveyors 88, 90 is set to be at or substantially at the height of the forming parts 26 of the elongate formers 68, 70 and 72, 74. As the corrugated flexible material 102′, still having the elongate formers 68, 70 and 72, 74 disposed in the corrugations 114, passes into the nip of the conveyor belts 92 along with the first and second liners 104, 106, the adhesive covered surfaces 108, 110 of the first and second liners 104, 106 are simultaneously or substantially simultaneously pressed onto the topside and bottomside ridges 116, respectively, of the corrugations 114 by the conveyors 88, 90, so that the first and second liners 104 and 106 are bonded to the corrugated flexible material 102′ sandwiched therebetween.

The corrugated lined material 102″, still having the elongate formers 68, 70 and 72, 74 positioned in the corrugations 114, continues to be moved along the guide path 14 by the conveyors 88, 90.

The endless tracks 46, 48 and 50, 52 then diverge, causing the elongate formers 68, 70 and 72, 74 positioned in the corrugations 114 of the corrugated lined material 102″ to be extracted from the corrugations 114 while still being supported by the conveyors 88, 90.

The corrugated lined material 102″ exits from between the conveyor belts 92 and can be cut to size.

The extracted elongate formers 68, 70 and 72, 74, supported by the conveyors 88, 90, continue around the endless tracks 46, 48 and 50, 52 and back upstream towards the respective corrugating rollers 16, 18. As the top and bottom corrugating rollers 16, 18 are approached, the transversely opposing endless tracks 46, 48 and 50, 52 converge causing the elongate formers 68, 70 and 72, 74 to be brought back towards each other in preparation for re-engagement with the corrugating rollers 16, 18.

In a modification to the embodiment, the longitudinal forming part of each elongate former extends the width of the guide path. Only two sets of elongate formers thus need be provided, one set to be associated with the top corrugating roller and one set to be associated with the bottom corrugating roller. Consequently, only two endless tracks also need be provided.

The two sets of elongate formers are interdigitated at the nip between the top and bottom corrugating rollers and during their downstream movement before being transversely extracted from the corrugations formed in the flexible material.

In a further modification, the bodies of the rollers could be replaced by fixed arcuate surfaces, leaving only the rotatable holder engaging portions to engage the holders of the elongate formers and drive the elongate formers around the endless tracks.

It is also contemplated that the rotatable members could be conveyors.

It will of course be understood that, although the corrugating machine has been described as forming corrugations having flat ridges and flat sides, corrugations having other profiles can be produced, for example ridges and sides having radii. by use of elongate formers having other transverse cross-sectional shapes.

The adhesive means could also apply adhesive to the flats of the corrugations instead of, or in addition to, the opposing surfaces of the liners.

It is thus possible to provide a corrugating machine which forms corrugations having flat ridges, thereby increasing the surface area available for adhering first and second liners and decreasing the chances of delamination. It is also possible to provide a corrugating machine which simultaneously or substantially simultaneously lines the corrugated flexible material, and to use a more cost-effective type of adhesive which can be applied cold in unregulated ambient conditions.

Furthermore, since the corrugations are formed by only bending the flexible material a limited number of times, an increase in the compressive strength due to the flat ridges and flat sides, can be realised in comparison to corrugations which follow a continuously curved surface.

The embodiments described above are given by way of examples only and various other modifications will be apparent to persons skilled in the art without departing from the scope of the present invention as defined by the appended claims. For example, the flexible material could be a plastics material or any other suitable material.

What is claimed is:

1. A corrugating machine comprising a guide path along which a sheet of flexible material can be fed, a pair of rotatable members between which the guide path extends, and a plurality of elongate corrugating formers which can be engaged with and disengaged from the rotatable members, the rotatable members being spaced so that, in use, the elongate corrugating formers, when engaged with the rotatable members, cooperate to form corrugations in the flexible sheet as the flexible sheet passes between the rotatable members.

2. A corrugating machine as claimed in claim 1, further comprising means, downstream of the rotatable members, for feeding first and second liners into the guide path, so that the first and second liners sandwich the corrugated flexible material therebetween.

3. A corrugating machine as claimed in claim 2, wherein the first and second liners are fed into the guide path simultaneously or substantially simultaneously.

4. A corrugating machine as claimed in claim 2, further comprising means for applying an adhesive to opposing surfaces of the first and second liners prior to being fed in to the guide path so that, when the corrugated flexible material is sandwiched therebetween, the first and second liners are bonded to the corrugated flexible material.

5. A corrugating machine as claimed in claim 1, wherein the elongate formers have a square or rectangular shaped transverse cross-section so that corrugations having flat or substantially flat ridges can be formed in the flexible material.

6. A corrugating machine as claimed in claim 1, wherein each elongate former includes a separate holder.

7. A corrugating machine as claimed in claim 6, wherein each rotatable member includes a holder engaging element at each end for engagement with the holders of the elongate formers.

8. A corrugating machine as claimed in claim 1, wherein the plurality of elongate formers are divided into four sets, and each rotatable member is associated with two of the sets.

9. A corrugating machine as claimed in claim 7, wherein the plurality of elongate formers are divided into four sets, and each rotatable member is associated with two of the sets and wherein the elongate formers of two of the four sets extend from the respective holders in a first direction, and the elongate formers of the other two sets extend from the respective holders in a second direction.

10. A corrugating machine as claimed in claim 9, wherein the holders of each set of elongate formers are slidable along an endless track, the tracks being positioned adjacent to respective ends of the rotatable members so that the holders are moved around the tracks by movement of the rotatable members.

11. A corrugating machine as claimed in claim 10, wherein a part of each endless track extends along the guide path so that the elongate formers can move along the guide path.

12. A corrugating machine as claimed in claim 10, wherein the endless tracks cause the elongate formers to be moved transversely to the guide path so that, in use, the elongate formers are withdrawn from the corrugations as the flexible material moves along the guide path.

13. A corrugating machine as claimed in claim 1, further comprising first and second conveyors having first and second conveyor belts, the first and second conveyors being located downstream of the rotatable members and positioned so that the guide path is sandwiched therebetween.

14. A corrugating machine as claimed in claim 4, wherein the adhesive can be applied cold.

15. A corrugating machine as claimed in claim 4, wherein the adhesive is a polyvinyl acetate (PVA) adhesive.

16. A corrugating machine comprising a guide path along which a sheet of flexible material can be fed, a plurality of sets of elongate corrugating formers, a holder at one end of each elongate former, the elongate formers of a first set extending from respective holders in a first direction and the elongate formers of a second set extending from respective holders in a second direction opposite the first direction, means for guiding the holders of each set of elongate formers along an endless track and for moving the elongate formers transversely of the guide path, and a pair of rotatable members which drive the elongate formers around arcuate paths at the upstream end of the guide path while a sheet of flexible material to be corrugated is passed along the guide path between the two sets of elongate formers.

17. A corrugating machine as claimed in claim 16, wherein the first and second sets of elongate formers are interdigitated when the flexible material is therebetween.

18. A corrugating machine as claimed in claim 16, wherein third and fourth sets of the elongate formers are also provided, the third set extending in the same direction as the first set and the fourth set extending in the same direction as the second set, the elongate formers of the first and fourth sets and the second and third sets being longitudinally aligned with each other.

19. A corrugating machine comprising a guide path along which a sheet of flexible material can be fed, a pair of rotatable members between which the guide path extends, a plurality of elongate corrugating formers on the rotatable members, and means, downstream of the rotatable members, for feeding first and second liners into the guide path, the rotatable members being spaced so that, in use, the elongate corrugating formers cooperate to form corrugations in the flexible material as the flexible material passes between the rotatable members, and first and second liners are simultaneously or substantially simultaneously fed from the first and second liner feeding means to sandwich the corrugated flexible material therebetween.

20. A corrugating machine as claimed in claim 19, further comprising means for applying an adhesive to opposing surfaces of the first and second liners prior to being fed into the guide path so that, when the corrugated flexible material is sandwiched therebetween, the first and second liners are bonded to the corrugated flexible material.

21. Corrugated material comprising corrugations having flat or substantially flat ridges and flat or substantially flat sides.

22. Corrugated material as claimed in claim 21, further comprising first and second liners positioned on the ridges of the corrugations.
